(19) United States
(12) Patent Application Publication
(10) Pub. No.: US 2005/0192905 A1
(43) Pub. Date: Sep. 1, 2005

(54) Licensing method for an electronic file

(76) Inventors: Caleb C. Rutan, Ann Arbor, MI (US); Christopher P. Flynn, Ypsilanti, MI (US)

Correspondence Address: SCHOX PLC, 209 NORTH STREET, #200, ANN ARBOR, MI, 48104, US

(21) Appl. No.: 10/790,359

(22) Filed: Mar. 1, 2004

(51) Int. Cl. H04K 1/00

(52) U.S. Cl. 705/59

(57) ABSTRACT

The invention is a licensing method between a server, a first client, and a second client for an electronic file. The method is preferably implemented with computer software, but may be implemented with any suitable device. In the preferred embodiment, the licensing method includes four steps, in which step (0) includes transferring the electronic file to the first client, step (1) includes transferring a first license to the first client, step (2) includes modifying the first license, and step (3) includes transferring a second license to the second client. The transition from step (1) to step (2) is preferably triggered by an event, such as the transfer of the electronic file from the first client to the second client. Although the preferred embodiment includes all four steps, alternative embodiments may include any suitable permutation of any suitable subset of steps (1), (2), (3), and (4), with or without repeated steps.

### TECHNICAL FIELD

This invention relates generally to the field of information technology, and more specifically to a new and useful method and system of distributing and licensing an electronic file.

### BACKGROUND

In the business of distributing books and other documents, a transition from the physical realm to the electronic realm has begun. There are many advantages to this movement. From the document buyer standpoint, a customer could save a small library of electronic books on a single device, such as a laptop computer. From the document seller standpoint, the transfer of an electronic document is much easier than the shipment of a physical document. For those trying to protect the intellectual property (such as a copyright) on the document, this movement from the physical realm to the electronic realm poses some problems. In the physical realm, it is difficult to simultaneously share a single document, which promoted individual purchases of the document. In the electronic realm, on the other hand, it is simple to copy and distribute multiple copies of a single document and to simultaneously access the single document. Thus, there is a need in the field of information technology for a method and system of distributing and licensing an electronic file.

### BRIEF DESCRIPTION OF THE FIGURES

FIG. 1 is a schematic representation of step (0) of the preferred embodiment.

FIG. 2 is a schematic representation of step (1) of the preferred embodiment.

FIG. 3 is a schematic representation of an event that signals the transition between step (1) and step (2) of the preferred embodiment.

FIGS. 4A and 4B are schematic representations of step (2) of the preferred embodiment.

FIG. 5 is a schematic representation of step (3) of the preferred embodiment.

### DESCRIPTION OF THE PREFERRED EMBODIMENT

The following description of the preferred embodiment of the invention is not intended to limit the invention to this preferred embodiment, but rather to enable any person skilled in the art of distributing and licensing an electronic file to make and use this invention.

The invention is a licensing method between a server, a first client, and a second client for an electronic file. The method is preferably implemented with computer software, but may be implemented with any suitable device. In the preferred embodiment, the licensing method includes four steps, in which step (0) includes transferring the electronic file to the first client, step (1) includes transferring a first license to the first client, step (2) includes modifying the first license, and step (3) includes transferring a second license to the second client. The transition from step (1) to step (2) is preferably triggered by an event, such as the transfer of the electronic file from the first client to the second client. Although the preferred embodiment includes all four steps, alternative embodiments may include any suitable permutation of any suitable subset of steps (1), (2), (3), and (4), with or without repeated steps.

In the preferred embodiment, the first and second clients are computers designed for a single user and equipped with a browser and a rights manager, while the server is a computer designed for multiple users and equipped with a relatively large memory. In alternative embodiments, the first client, second client, and server may be any suitable device or any combination of several devices that are equipped with any suitable software. As an example, the term “server” as used through the detailed description and the claims may actually include one or more computers. The first client is preferably connectable to the second client through a direct connection (using Ethernet, Bluetooth, modem, or any other suitable technology) or through a network connection (such as a LAN or LAWN), but may be connected with any suitable connection. Similarly, the first and second clients are preferably connectable to the server through a network connection (such as a LAN or LAWN), but may be connected with any suitable connection.

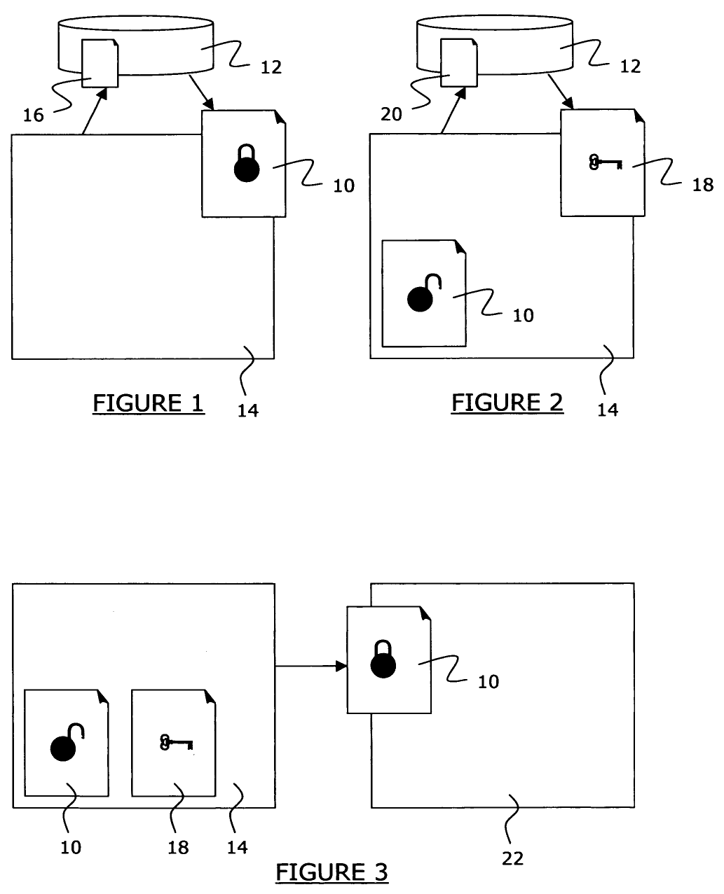

As shown in FIG. 1, step (0) includes transferring an electronic file 10 from the server 12 to the first client 14. In the preferred embodiment, step (0) includes requesting the electronic file 10, receiving the file request 16, transferring the electronic file 10 from the server 12 to the first client 14, receiving the electronic file 10, and allowing an initial set of permissible actions with the electronic file 10. In alternative embodiments, step (0) may include more, or fewer, suitable actions. Requesting the electronic file is preferably initiated after an input from a user and is preferably accomplished with a browser or other suitable application. Transferring and receiving the electronic file is preferably accomplished with a browser over an Internet connection, but may be accomplished in any suitable manner (such as by a optical reader from an optical disk). The electronic file preferably includes data such as document data, audio data, image data, and video data, but may include software such as application software and operating system software. The rights manager preferably allows an initial set of permissible actions with the electronic file regardless of a connection between the first client and the server. These initial rights preferably include the copy and delete actions, but may include other suitable actions.

As shown in FIG. 2, step (1) includes transferring a first license 18 from the server 12 to the first client 14. In the preferred embodiment, step (1) includes requesting a license from the server 12, receiving a license request 20 from the first client 14, generating a first license 18 based on an attribute of the first client 14, transferring a first license 18 from the server 12 to the first client 14, receiving the first license 18 from the server 12, and allowing a first set of licensed actions with the electronic file 1o based on the first license 18. In alternative embodiments, step (1) may include more, or fewer, suitable actions. Preferably, the rights manager automatically requests a license from the server over the Internet upon the receipt of the electronic file by the first client. Alternatively, a user of the first client may request a license.

Preferably, the server (or another suitable device or application connected to the server) generates the first license specifically for the first client. In a first variation, the first license is generated based on a machine identification of the first client. In a second variation, the first license is generated based on a user identification of the first client. In other variations, the first license may be generated based on any suitable attribute of the first client. In the preferred embodiment, the requesting and transferring of the license occurs between the first client and the server over an Internet connection. Because the first client initiates the communication, the communication is preferably unaffected by a firewall between the first client and the server. Upon the receipt of the first license, the rights manager preferably allows a first set of licensed actions with the electronic file based on the first license. The rights manager preferably allows the first set of licensed actions with the electronic file regardless of a connection between the first client and the server. These initial rights, which are preferably less restrictive than the initial set of permissible actions, preferably include the print and open actions, but may other suitable actions.

The transition from step (1) to step (2) is preferably triggered by the occurrence of an event. The user of the first client preferably initiates the event. In one variation, as shown in FIG. 3, the event is the transfer of a copy of the electronic file 10 from the first client 14 to the second client 22 and a request from a user of the first client to transfer the license to the second client (or revoke the license of the first client and to create a license for the second client). In another variation (not shown), the event may be an update of the first license through a purchase (or a complaint). The transition from step (1) to step (2) may alternatively be triggered by the occurrence of any suitable event.

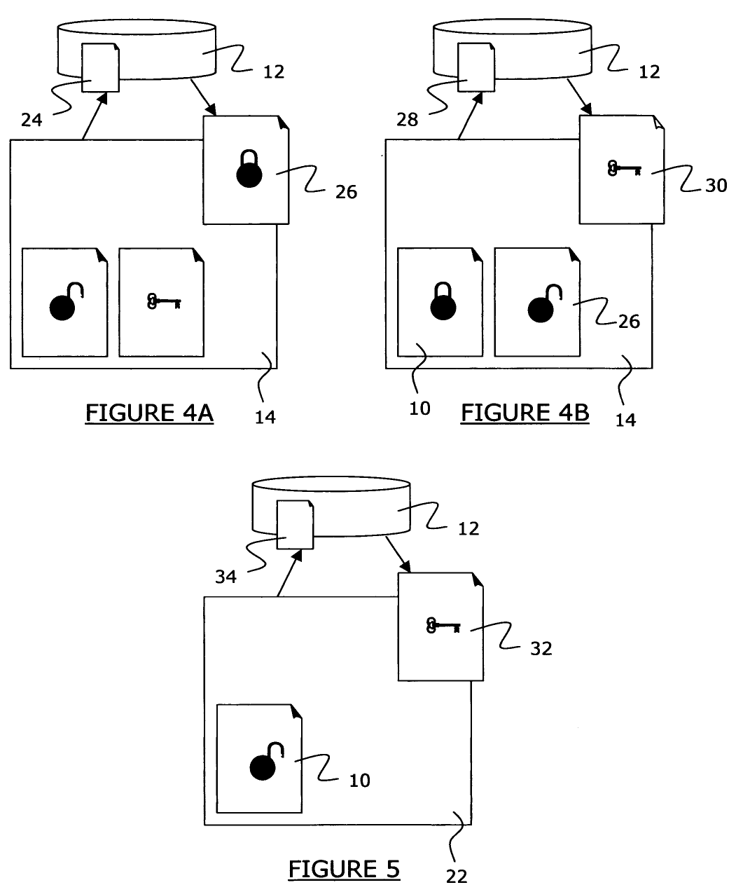

Step (2) includes modifying the first license. In the preferred embodiment, step (2) includes requesting a license from the server, receiving a license request from the first client, and modifying the first license. In alternative embodiments, step (2) may include more, or fewer, suitable actions. Requesting a license from the server may be accomplished in several ways. In the preferred embodiment, as shown in FIG. 4A, the rights manager requests a so-called dummy file from the server and the server receives the dummy file request 24 and transfers the dummy file 26 to the first client 14. Upon the receipt of the dummy file by the first client, the rights manager requests a license for the dummy file. In an alternative embodiment, the rights manager could directly request a license from the server. As shown in FIG. 4B, the server 12 modifies the first license upon the receipt of a license request 28 from the first client 14. Again, because the first client initiates the communication, the modification of the first license is preferably unaffected by a firewall between the first client and the server.

Modifying the first license may also be accomplished in several ways. In a first variation, the server preferably transfers an empty license to the first client that replaces the first license. Upon receipt of an empty license from the server, the rights manager preferably allows the initial set of permissible actions with the electronic file. This initial set of permissible actions, as mentioned above, is preferably more restrictive than the first set of licensed actions. The rights manager preferably allows the initial set of permissible actions with the electronic file regardless of a connection between the first client and the server. In another variation (shown in FIG. 4B), the first license may represent the possible actions for several electronic files. Thus, transferring an empty license that replaces the first license may inadvertently prevent actions with the other electronic files. In this variation, the server 12 preferably transfers a modified license 30 to the first client 14 that replaces the first license 18. Upon receipt of the modified license 30 from the server 12, the rights manager preferably allows a modified set of licensed actions with the electronic file lo. This modified set of licensed actions is preferably more restrictive than the first set of licensed actions, but may alternatively be less restrictive (or simply different) than the first set of licensed actions. The rights manager preferably allows the modified set of licensed actions with the electronic file regardless of a connection between the first client and the server.

As shown in FIG. 5, step (3) includes transferring a second license 32 to the second client 22. Except for the difference between the first client and the second client, step (3) is preferably identical to step (1). Similar to step (1), step (3) includes requesting a license from the server 12, receiving a license request 34 from the second client 22, generating a second license 32 based on an attribute of the second client 22, transferring the second license 32 to the second client 22, receiving a second license 32 from the server 22, and allowing a second set of licensed actions with the electronic file 10 based on the second license 32. In alternative embodiments, step (3) may include more, or fewer, suitable actions. Preferably, the rights manager automatically requests a license from the server over the Internet upon the receipt of the electronic file by the second client. Alternatively, a user of the second client may request a license.

The server (or another suitable device or application connected to the server) preferably generates the second license specifically for the second client. In the preferred embodiment, the requesting and transferring of the license occurs between the second client and the server over an Internet connection. Because the second client initiates the communication, the communication is preferably unaffected by a firewall between the second client and the server. Upon the receipt of the second license, the rights manager preferably allows a second set of licensed actions (which is preferably substantially similar to the first set of licensed actions) with the electronic file based on the second license. The rights manager preferably allows the second set of licensed actions with the electronic file regardless of a connection between the second client and the server.

As a person skilled in the art of distributing and licensing an electronic file will recognize from the previous detailed description and from the figures and claims, modifications and changes can be made to the preferred embodiment of the invention without departing from the scope of this invention defined in the following claims.

1. A licensing method for an electronic file between a server, a first client, and a second client, comprising the steps of:
(1) requesting a license from the server, transferring a first license to the first client, and allowing a first set of licensed actions with the electronic file based on the first license; and
(2) upon the occurrence of an event, requesting a license from the server and modifying the first license.

2. The licensing method of claim 1, further comprising the step of:
(0) requesting the electronic file, transferring the electronic file to the first client, and allowing an initial set of permissible actions with the electronic file.

3. The licensing method of claim 2, wherein the electronic file includes data selected from the group consisting of: document data, audio data, image data, and video data.

4. The licensing method of claim 2, wherein the electronic file includes software selected from the group consisting of: application software and operating system software.

5. The licensing method of claim 2, wherein step (0) further includes allowing an initial set of permissible actions with the electronic file regardless of a connection between the first client and the server.

6. The licensing method of claim 5, wherein the first set of licensed actions is less restrictive than the initial set of permissible actions.

7. The licensing method of claim 2, wherein step (1) further includes requesting a license from the server upon the receipt of the electronic file.

8. The licensing method of claim 1, wherein step (1) further includes receiving a license request from the first client.

9. The licensing method of claim 8, wherein step (1) further includes generating a first license based on an attribute of the first client.

10. The licensing method of claim 9, wherein the attribute is a machine identification of the first client.

11. The licensing method of claim 9, wherein the attribute is a user identification of the first client.

12. The licensing method of claim 1, wherein step (1) further includes allowing a first set of licensed actions regardless of a connection between the first client and the server.

13. The licensing method of claim 1, wherein the event is a transfer of the file from the first client to the second client.

14. The licensing method of claim 13, wherein step (2) further includes requesting a dummy file upon the transfer of the file from the first client to the second client.

15. The licensing method of claim 14, wherein step (2) further includes receiving the dummy file and requesting a license from the server upon the receipt of the dummy file.

16. The licensing method of claim 1, wherein step (2) further includes receiving a license request from the first client.

17. The licensing method of claim 16, wherein step (2) further includes transferring an empty license to the first client and, upon receipt of an empty license from the server, allowing an initial set of permissible actions with the electronic file.

18. The licensing method of claim 17, wherein the initial set of permissible actions is more restrictive than the first set of licensed actions.

19. The licensing method of claim 17, wherein step (2) further includes allowing an initial set of permissible actions regardless of a connection between the first client and the server.

20. The licensing method of claim 16, wherein step (2) further includes transferring a modified license to the first client and, upon receipt of the modified license from the server, allowing a modified set of licensed actions with the electronic file.

21. The licensing method of claim 20, wherein the modified set of licensed actions is more restrictive than the first set of licensed actions.

22. The licensing method of claim 20, wherein step (2) further includes allowing a modified set of licensed actions regardless of a connection between the first client and the server.

23. The licensing method of claim 1, further comprising the step of:
(3) receiving a license request from the second client and transferring a second license to the second client that allows a second set of licensed actions with the electronic file.

24. The licensing method of claim 23, wherein step (3) further includes generating a second license based on an attribute of the second client.

25. The licensing method of claim 23, wherein the second set of licensed actions is substantially similar to the first set of licensed actions.

26. A licensing method for an electronic file between a server, a first client, and a second client, comprising the steps of:
(1) transferring a first license to the first client that allows a first set of licensed actions with the electronic file;
(2) upon a transfer of the file from the first client to the second client, modifying the first license; and
(3) transferring a second license to the second client that allows a second set of licensed actions with the electronic file.

27. The licensing method of claim 26, further comprising the step of:
(0) transferring the electronic file to the first client.

28. The licensing method of claim 27, wherein the electronic file includes data selected from the group consisting of: document data, audio data, image data, and video data.

29. The licensing method of claim 27, wherein the electronic file includes software selected from the group consisting of: application software and operating system software.

30. The licensing method of claim 26, wherein step (1) further includes receiving a license request from the first client.

31. The licensing method of claim 30, wherein step (1) further includes generating a first license based on an attribute of the first client.

32. The licensing method of claim 31, wherein the attribute is a machine identification of the first client.

33. The licensing method of claim 31, wherein the attribute is a user identification of the first client.

34. The licensing method of claim 26, wherein step (2) further includes receiving a license request from the first client.

35. The licensing method of claim 34, wherein step (2) further includes transferring an empty license to the first client.

36. The licensing method of claim 34, wherein step (2) further includes transferring a modified license to the first client that replaces the first license and allows a modified set of licensed actions with the electronic file.

37. The licensing method of claim 34, wherein the modified set of licensed actions is more restrictive than the first set of licensed actions.

38. The licensing method of claim 26, wherein step (3) further includes receiving a license request from the second client.

39. The licensing method of claim 38, wherein step (3) further includes generating a second license based on an attribute of the second client.

40. The licensing method of claim 26, wherein the second set of licensed actions is substantially similar to the first set of licensed actions.

41. A licensing method for an electronic file between a server, a first client, and a second client, comprising the steps of:
(1) requesting a license from the server, receiving a first license from the server, and allowing a first set of licensed actions with the electronic file based on the first license; and
(2) upon the occurrence of an event, requesting a license from the server.

42. The licensing method of claim 41, further comprising the step of:
(0) requesting the electronic file, receiving the electronic file, and allowing an initial set of permissible actions with the electronic file.

43. The licensing method of claim 42, wherein the electronic file includes data selected from the group consisting of: document data, audio data, image data, and video data.

44. The licensing method of claim 42, wherein the electronic file includes software selected from the group consisting of: application software and operating system software.

45. The licensing method of claim 42, wherein step (0) further includes allowing the initial set of permissible actions with the electronic file regardless of a connection between the first client and the server.

46. The licensing method of claim 45, wherein the first set of licensed actions is less restrictive than the initial set of permissible actions.

47. The licensing method of claim 42, wherein step (1) further includes requesting a license from the server upon the receipt of the electronic file.

48. The licensing method of claim 41, wherein step (1) further includes allowing a first set of licensed actions regardless of a connection between the first client and the server.

49. The licensing method of claim 41, wherein the event is a transfer of the file from the first client to the second client.

50. The licensing method of claim 49, wherein step (2) further includes requesting a dummy file upon the transfer of the file from the first client to the second client.

51. The licensing method of claim 50, wherein step (2) further includes receiving the dummy file and requesting a license from the server upon the receipt of the dummy file.

52. The licensing method of claim 41, wherein step (2) further includes receiving an empty license from the server and, based on the empty license, allowing an initial set of permissible actions with the electronic file.

53. The licensing method of claim 52, wherein the initial set of permissible actions is more restrictive than the first set of licensed actions.

54. The licensing method of claim 52, wherein step (2) further includes allowing an initial set of permissible actions regardless of a connection between the first client and the server.

55. The licensing method of 41, wherein step (2) further includes receiving a modified license from the server and, based on the modified license, allowing a modified set of licensed actions with the electronic file.

56. The licensing method of claim 55, wherein the modified set of licensed actions is more restrictive than the first set of licensed actions.

57. The licensing method of claim 55, wherein step (2) further includes allowing a modified set of licensed actions regardless of a connection between the first client and the server.
